(19) United States
(12) Patent Application Publication
(10) Pub. No.: US 2009/0123722 A1
(43) Pub. Date: May 14, 2009

(54) Coating system

(76) Inventors: David B. Allen, Oviedo, FL (US); Eckart Schumann, Mulheim an der Ruhr (DE); Ramesh Subramanian, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/983,373

(22) Filed: Nov. 8, 2007

(51) Int. Cl. B32B 3/26

(52) U.S. Cl. 428/220; 428/304.4

(57) ABSTRACT

The invention relates to a coating system (2) for a component (1) which comprises a porous layer (3) and an abradable layer (4) on the porous layer (3). Further the invention relates to an assembly of two components (1) which are relatively movable to each other and form a gap in between. One component (1) is provided with a coating system (2) and the other component (1) is in sliding contact with the coating system (2).

### FIELD OF INVENTION

The invention relates to a coating system for a component and to an assembly of two components which are relatively movable to each other.

### BACKGROUND OF THE INVENTION

Many components which are used in a chemical aggressive environment have to withstand high temperatures above 1000° C. Therefore they must be protected to ensure a long lifetime. This is especially true for components which are part, of modern gas turbines because it is a general trend to raise the firing temperature in order to improve efficiency.

Accordingly most components in the hot section of a gas turbine are made of highly resistant alloys. Further they are protected with special coating systems. These coating systems can comprise a bond layer on the metallic substrate, an oxidation resistant layer, i.e. a MCrAlX-layer on the bond coat and one or more ceramic layers which possess heat insulating properties. The combination of layers forms a thermal barrier coating which protects the component.

A critical aspect in gas turbine design is to seal gaps between moving parts in the hot section. If the sealing is insufficient, hot gas may leak whereby the overall efficiency of the turbine is reduced. Again the sealing means has to withstand high temperatures in an aggressive atmosphere. To meet the objects of consistency and resistance abradable coating systems are used.

The abradable coating system is provided on one component of an assembly of two relatively movable components, which form a gap in-between. The other component is arranged in sliding contact with the abradable coating system. Hereby the gap between the components is sealed. During operation, when the two components move relatively to each other, the uncoated component rubs off part of the abradable coating.

Known abradable coating systems comprise a bond coat and at least one abradable layer made of ceramics. In many cases the ceramics contain ZrO₂ which is stabilized by Y₂O₃ and/or and/or Yb₂O₃.

During use the abradable layer looses some of its abradable property because of sintering effects which increase the hardness of the layer. As a result part of the substrate of the uncoated component is rubbed off, whereby the consistency of the seal is reduced and an earlier substitution of the uncoated component becomes necessary.

An improved coating system which reduces this effect is disclosed in EP 1 484 426 A2. It comprises a bond coat and a first and a second layer of zirconium both stabilized by one of Y₂O₃ and Yb₂O₃. Nevertheless the abradable property of the coating system is negatively affected when it is exposed to high temperature because to a certain degree sintering still occurs.

### SUMMARY OF INVENTION

Therefore it is an object of the present invention to provide a coating system which possesses a further improved resistance against sintering effects.

This object is solved by an abradable ceramic layer which is provided on a porous ceramic layer.

Surprisingly it has been found that the resistance of a coating system against sintering can be further improved if an abradable ceramic layer is provided on a porous ceramic layer. In this case the coating system as a whole keeps its abradable property even if it is exposed to high temperatures for a long period time.

According to a first embodiment of the invention the porous ceramic layer has a porosity of ≧20 vol %, preferably of ≧22 vol % and ≦28 vol % and more preferably of ≧24 vol % and ≦26 vol %.

It is also possible that the porous ceramic layer comprises ceramic material. This can be ZrO₂ which is stabilized by Yb₂O₃ and/or Y₂O₃. The amount of Y₂O₃ in the porous layer can be within the range of 6 wt % to 10 wt %. In a preferred embodiment the porous ceramic layer comprises 8 wt % Y₂O₃.

The porous ceramic layer can be 150 μm to 300 μm, preferably 180 μm to 250 μm, more preferably 190 μm to 240 μm and most preferably 225 μm thick.

According to another embodiment of the invention the abradable ceramic layer 4 can comprise ZrO₂ which is stabilized by Yb₂O₃ and/or Y₂O₃. In this case the amount of Yb₂O₃ can be at least 30 wt %, preferably 33 wt %.

In one preferred embodiment of the invention the abradable ceramic layer has a porosity of ≧20 vol %, preferably of ≧25 vol % and ≦40 vol % and more preferably of ≧27 vol % and ≦35 vol %.

The abradable ceramic layer can be 300 μm to 800 μm, preferably 350 μm to 700 μm, more preferably 400 μm to 600 μm and most preferably 500 μm thick.

According to still another embodiment of the invention the coating system comprises a ceramic layer below the porous ceramic layer. Preferably the ceramic layer has a smaller porosity than the porous ceramic layer.

The ceramic layer can comprise ZrO₂ which is stabilized by Y₂O₃ and/or Yb₂O₃. Preferably the amount of Y₂O₃ is within the range of 6 wt % to 10 wt %, more preferably it is 8 wt %.

It is also possible that the ceramic layer is 20 μm to 200 μm, preferably 30 μm to 150 μm, more preferably 40 μm to 100 μm and most preferably 75 μm thick.

Another preferred embodiment of the invention concerns a coating system wherein the ceramic layer, the porous ceramic layer 3 and the abradable ceramic layer are together 650 μm to 950 μm thick.

Furthermore a metallic bond coat can be provided below the porous layer or the ceramic layer. The bond coat 5 can be 100 μm to 260 μm, preferably 130 μm to 230 μm, more preferably 150 μm to 200 μm and most preferably 180 μm thick.

Still another embodiment of the invention concerns a coating system which is provided on a gas turbine component.

A second aspect of the invention provides an assembly of two relatively movable components which form a gap in between, wherein one component is provided with a coating system according to one of the claims 1 to 20 and the other components is arranged in sliding contact with the coating system. Preferably the components are part of a gas turbine.

### BRIEF DESCRIPTION OF THE DRAWINGS

Next two embodiments of the present invention will be described in detail with reference to the accompanying drawing. In the drawing

FIG. 1 shows a first embodiment of the invention; and

FIG. 2 shows a second embodiment of the invention.

FIG. 3 shows a gas turbine,

FIG. 4 shows a turbine blade,

FIG. 5 shows a combustion chamber,

FIG. 6 shows a list of superalloy.

### DETAILED DESCRIPTION OF INVENTION

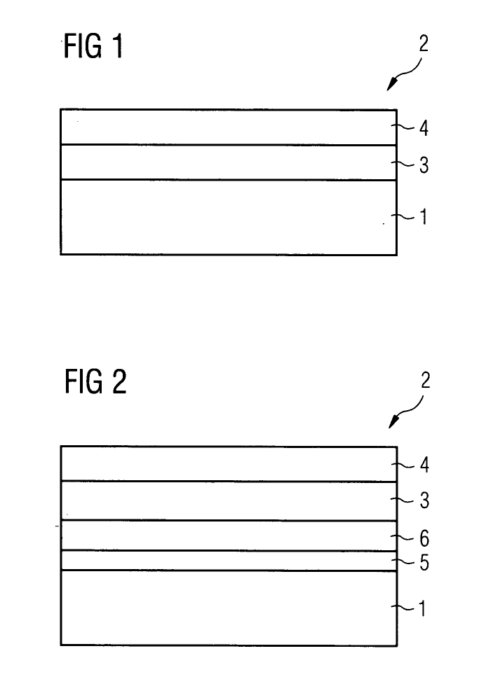

FIG. 1 shows a first embodiment of the invention.

A component 2, 120, 130 is provided as a coating system 2. The coating system 2 comprises a porous layer 3 on said substrate 1 and an abradable layer 4 provided on the porous layer 3.

The porous ceramic layer 3 has a porosity of ≧20 vol % and it comprises ZrO₂ which preferably is stabilized by 6 wt % to 10 wt % Y₂O₃. Further it is 150 μm to 300 μm thick. Preferably ZrO₂ of the porous ceramic layer 3 is only stabilized by Y₂O₃.

The abradable ceramic layer 4 comprises preferably ZrO₂ which is stabilized by at least 30 wt % Yb₂O₃.

Preferably the abradable ceramic layer is only stabilized by Y₂O₃.

I 4 has a porosity of ≧20 vol % and it is 300 μm to 800 μm thick.

FIG. 2 shows a second embodiment of the invention which is similar to the first embodiment shown in FIG. 1. Accordingly similar parts are designated with the same reference numerals.

A component 2 is provided as a coating system 2 comprising four different layers. The surface of the substrate 1 is preferably covered with a bond coat 5 which is 100 μm to 260 μm thick.

On the metallic bond coat 5 a ceramic layer 6 is provided. The ceramic layer 6 comprises ZrO₂ which is stabilized by 6 wt % to 10 wt % Y₂O₃ and it is preferably 20 μm to 200 μm thick.

On the bond coat 5 an oxide layer (TGO) is formed during applying the ceramic layer 6 or porous ceramic layer 3 or is formed at high temperatures during use. The ceramic layer 6 has preferably a porosity of 6 vol % to 17 vol % and more preferably of 8 vol % to 15 vol %.

The ceramic layer 6 is coated with a porous ceramic layer 3 which comprises ZrO₂ being stabilized with Y₂O₃ and/or Yb₂O₃. It 6 is 190 μm to 240 μm thick. Preferably the ZrO₂ of the ceramic layer is only stabilized by Yb₂O₃.

The last layer on the porous layer 3 is an abradable ceramic layer 4, which comprises ZrO₂ stabilized by 33 wt % Yb₂O₃.

It 4 is 400 μm to 600 μm thick.

These two coating systems 2 can withstand thermal, chemical and mechanical degradation. Furthermore they show a high resistance against sintering effects. Accordingly it can protect said substrate I sufficiently even if it is part of a gas turbine which is used in the hot section.

The coating systems 2 can be used to seal a gap between two relatively movable parts of an assembly. In this case one of the parts is provided with either of the coating systems 2 and the other part is arranged in sliding contact with the coating system 2. During the relative movement of the parts the uncoated part abrades part of the coating system 2. The coating system 2 does not loose its abradable property when it is exposed to heat, as only little or no sintering occurs. Therefore the coating systems 2 can be used to provide an abradable seal between two relatively movable parts, i.e. in the hot section of a gas turbine.

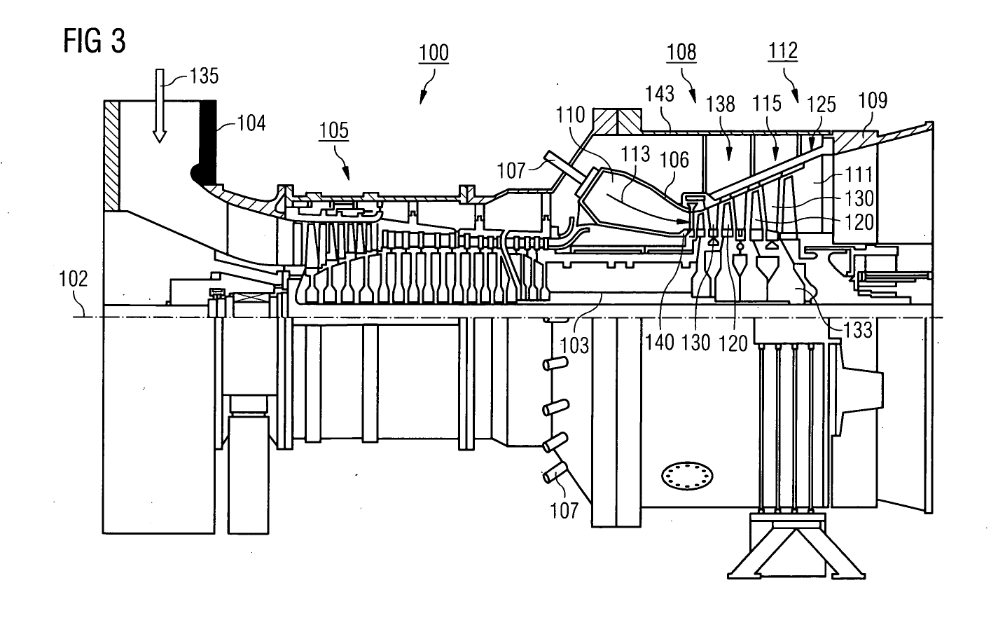

FIG. 3 shows a perspective view of a rotor blade 120 or guide vane 130 of a turbo machine, which extends along a longitudinal axis 121.

The turbo machine may be a gas turbine of an aircraft or of a power plant for generating electricity, a steam turbine or a compressor.

The blade or vane 120, 130 has a securing region 400, an adjoining blade or vane platform 403 and a main blade or main part 406 in succession along the longitudinal axis 121. As guide vane 130, the vane 130 may have a further platform (not shown) at its vane tip 415.

A blade or vane root 183, which is used to secure the rotor blades 120, 130 to a shaft or disk (not shown), is formed in the securing region 400. The blade or vane root 183 is designed, for example, in hammerhead form. Other configurations, such as fir-tree or dovetail root, are also possible. The blade or vane 120, 130 has a leading edge 409 and a trailing edge 412 for a medium which flows past the main blade or vane part 406.

In the case of conventional blades or vanes 120, 130, by way of example, solid metallic materials, in particular superalloys, are used in all regions 400, 403, 406 of the blade or vane 120, 130. Superalloys of this type are known, for example, from EP 1 204 776 B1, EP 1 306 454, EP 1 319 729 A1, WO 99/67435 or WO 00/44949; these documents form part of the present disclosure with regard to the chemical composition of the alloy. The blade or vane 120, 130 may in this case be produced by a casting process, also by means of directional solidification, by a forging process, by a milling process or combinations thereof.

Work pieces with a single-crystal structure or structures are used as components for machines which are exposed to high mechanical, thermal and/or chemical loads during operation. Single-crystal work pieces of this type are produced, for example, by directional solidification from the melt. This involves casting processes in which the liquid metallic alloy is solidified to form the single-crystal structure, i.e. the single-crystal work piece, i.e. directionally. In the process, dendritic crystals are formed in the direction of the heat flux and form either a columnar-crystalline grain structure (i.e. with grains which run over the entire length of the work piece and are referred to in this context, in accordance with the standard terminology, as directionally solidified) or a single-crystal structure, i.e. the entire work piece consists of a single crystal. In this process, the transition to globular (polycrystalline) solidification needs to be avoided, since non-directional growth inevitably leads to the formation of transverse and longitudinal grain boundaries, which negate the good properties of the directionally solidified or single-crystal component. Where directionally solidified microstructures are referred to in general, this is to be understood as encompassing both single crystals, which do not have any grain boundaries or at most have small-angle grain boundaries, and columnar crystal structures, which do have grain boundaries running in the longitudinal direction, but do not have any transverse grain boundaries. In the case of these latter crystalline structures, it is also possible to refer to directionally solidified microstructures (directionally solidified structures). Processes of this type are known from U.S. Pat. No. 6,024,792 and EP 0 892 090 A1; these documents form part of the present disclosure.

The blades or vanes 120, 130 may also have coatings protecting against corrosion or oxidation, e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of the present disclosure with regard to the chemical composition of the alloy.

It is also possible for a thermal barrier coating consisting, for example, of ZrO₂, Y₂O₄—ZrO₂, i.e. which is not, is partially or is completely stabilized by yttrium oxide and/or calcium oxide and/or magnesium oxide, to be present on the MCrAlX. Columnar grains are produced in the thermal barrier coating by suitable coating processes, such as for example electron beam physical vapor deposition (EB-PVD).

The term refurbishment means that protective layers may have to be removed from components 120, 130 after they have been used (for example by sandblasting). Then, the corrosion and/or oxidation layers or products are removed. If necessary, cracks in the component 120, 130 are also repaired using the solder according to the invention. This is followed by recoating of the component 120, 130, after which the component 120, 130 can be used again.

The blade or vane 120, 130 may be of solid or hollow design. If the blade or vane 120, 130 is to be cooled, it is hollow and may also include film cooling holes 418 (indicated by dashed lines).

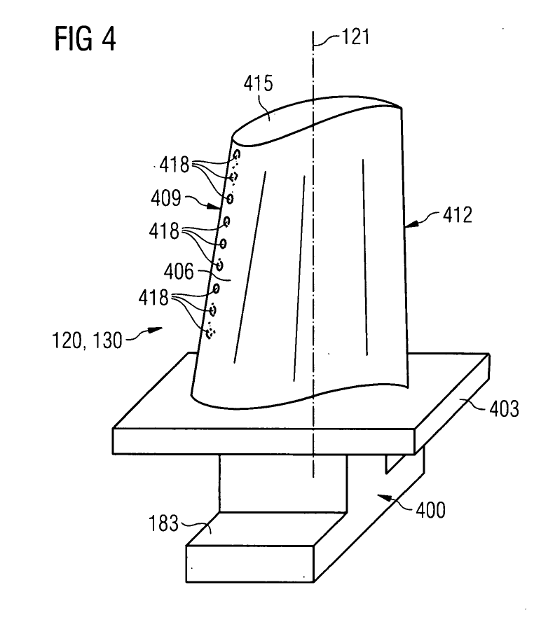

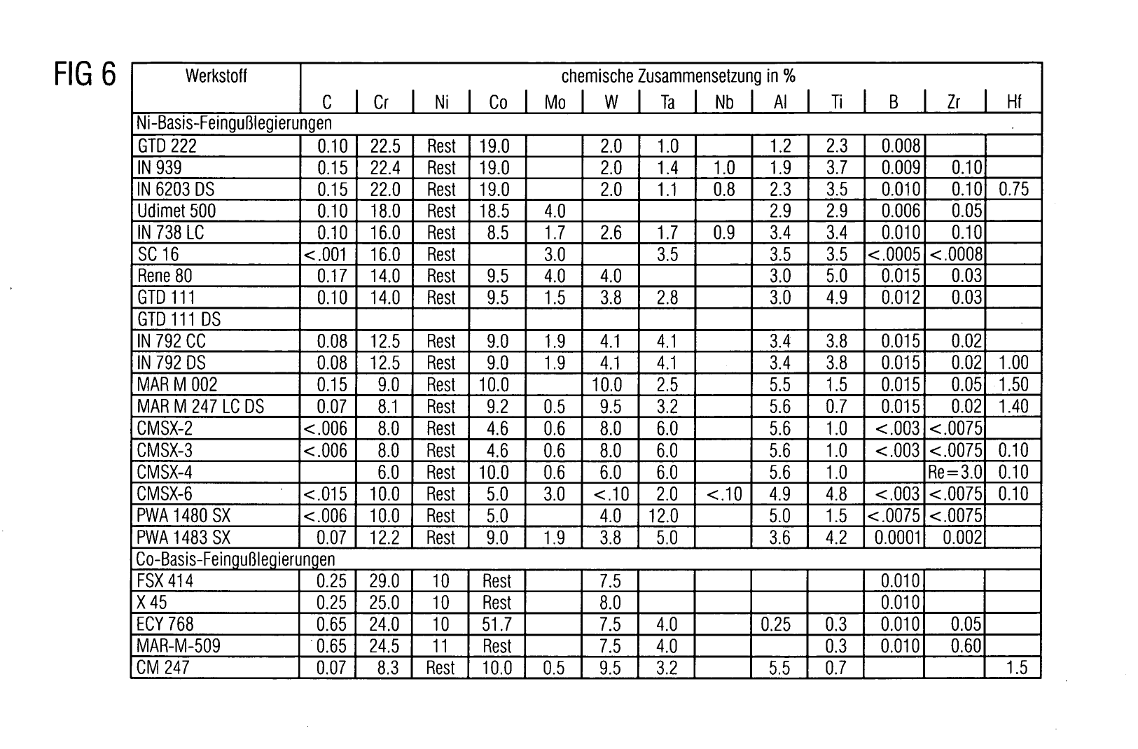

FIG. 4 shows a combustion chamber 110 of a gas turbine 100 (FIG. 6).

The combustion chamber 110 is configured, for example, as what is known as an annular combustion chamber, in which a multiplicity of burners 107, which are arranged around an axis of rotation 102 in the circumferential direction, open out into a common combustion chamber space 154, with the burners 107 producing flames 156. For this purpose, the combustion chamber 110 overall is of annular configuration, positioned around the axis of rotation 102.

To achieve a relatively high efficiency, the combustion chamber 110 is designed for a relatively high temperature of the working medium M of approximately 1000° C. to 1600° C. To allow a relatively long operating time even with these operating parameters, which are unfavorable for the materials, the combustion chamber wall 153 is provided with an inner lining formed from heat shield elements 155 on its side facing the working medium M. Each heat shield element 155 made from an alloy is equipped on the working medium side with a particularly heat-resistant protective layer (MCrAlX layer and/or ceramic coating) or is made from material that is able to withstand high temperatures (solid ceramic bricks). These protective layers may be similar to the turbine blades or vanes, i.e. meaning for example MCrAlX: M is at least one element selected from the group consisting of iron (Fe), cobalt (Co), nickel (Ni), X is an active element and stands for yttrium (Y) and/or silicon and/or at least one rare earth element, or hafnium (Hf). Alloys of this type are known from EP 0 486 489 B1, EP 0 786 017 B1, EP 0 412 397 B1 or EP 1 306 454 A1, which are intended to form part of the present disclosure with regard to the chemical composition of the alloy.

It is also possible for a, for example, ceramic thermal barrier coating to be present on the MCrAlX, consisting, for example, of ZrO₂, Y₂O₄—ZrO₂, i.e. it is not, is partially or is completely stabilized by yttrium oxide and/or calcium oxide and/or magnesium oxide.

Columnar grains are produced in the thermal barrier coating by suitable coating processes, such as for example electron beam physical vapor deposition (EP-PVD).

The term refurbishment means that protective layers may have to be removed from heat shield elements 155 after they have been used (for example by sandblasting). Then, the corrosion and/or oxidation layers or products are removed. If necessary, cracks in the heat shield element 155 are also repaired using the solder according to the invention. This is followed by recoating of the heat shield elements 155, after which the heat shield elements 155 can be used again.

Moreover, on account of the high temperatures in the interior of the combustion chamber 110, it is possible for a cooling system to be provided for the heat shield elements 155 and/or for their holding elements. The heat shield elements 155 are in this case, for example, hollow and may also include film cooling holes (not shown) which open out into the combustion chamber space 154.

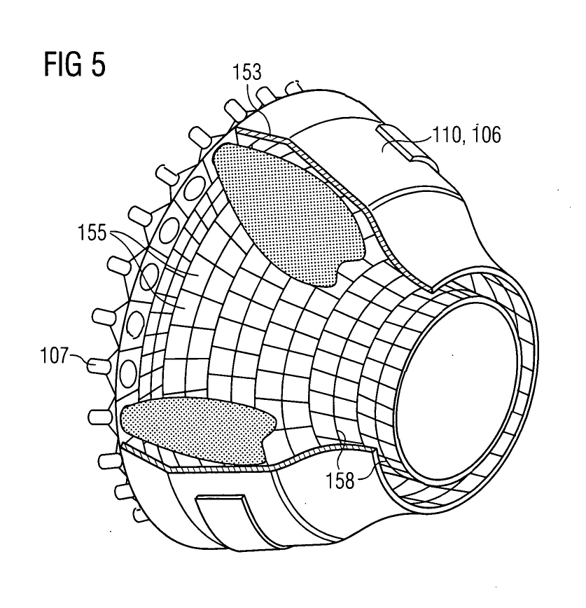

FIG. 5 shows, by way of example, a gas turbine 100 in the form of a longitudinal part section. In its interior, the gas turbine 100 has a rotor 103, which is mounted such that it can rotate about an axis of rotation 102 and has a shaft, also known as the turbine rotor. An intake housing 104, a compressor 105 a, for example toroidal, combustion chamber 110, in particular an annular combustion chamber, with a plurality of coaxially arranged burners 107, a turbine 108 and the exhaust casing 109 follow one another along the rotor 103. The annular combustion chamber 110 is in communication with a, for example annular, hot-gas duct 111 where, for example, four successive turbine stages 112 form the turbine 108.

Each turbine stage 112 is formed, for example, from two blade or vane rings. As seen in the direction of flow of a working medium 113, a row 125 formed from rotor blades 120 follows a row 115 of guide vanes in the hot-gas duct 111.

The guide vanes 130 are secured to an inner housing 138 of a stator 143, whereas the rotor blades 120 of a row 125 are fitted to the rotor 103, for example by means of a turbine disk 133. A generator or machine (not shown) is coupled to the rotor 103.

When the gas turbine 100 is operating, the compressor 105 sucks in air 135 through the intake housing 104 and compresses it. The compressed air which is provided at the turbine-side end of the compressor 105 is passed to the burners 107, where it is mixed with a fuel. The mixture is then burnt in the combustion chamber 110 to form the working medium 133. From there, the working medium 133 flows along the hot-gas duct 111 past the guide vanes 130 and the rotor blades 120. The working medium 113 expands at the rotor blades 120, transferring its momentum, so that the rotor blades 120 drive the rotor 103 and the rotor drives the machine coupled to it.

When the gas turbine 100 is operating, the components which are exposed to the hot working medium 113 are subject to thermal loads. The guide vanes 130 and rotor blades 120 of the first turbine stage 112, as seen in the direction of flow of the working medium 113, together with the heat shield elements which line the annular combustion chamber 110, are subject to the highest thermal loads. To withstand the temperatures prevailing there, these components can be cooled by means of a coolant.

It is likewise possible for substrates of the components to have a directional structure, i.e. they are in single-crystal form (SX structure) or include only longitudinally directed grains (DS structure). By way of example, iron-base, nickel-base or cobalt-base superalloys are used as material for the components, in particular for the turbine blades and vanes 120, 130 and components of the combustion chamber 110. Superalloys of this type are known, for example, from EP 1 204 776 B1, EP 1 306 454, EP 1 319 729 A1, WO 99/67435 or WO 00/44949; these documents form part of the present disclosure with regard to the chemical composition of the alloys.

The blades and vanes 120, 130 may likewise have coatings to protect against corrosion (MCrAlX; M is at least one element selected from the group consisting of iron (Fe), cobalt (Co), nickel (Ni), X is an active element and stands for yttrium (Y) and/or silicon and/or at least one of the rare earth elements or hafnium). Alloys of this type are known from EP 0 486 489 B1, EP 0 786 017 B1, EP 0 412 397 B1 or EP 1 306 454 A1, which are intended to form part of the present disclosure with regard to the chemical composition.

A thermal barrier coating consisting, for example, of ZrO₂, Y₂O₄—ZrO₂, i.e. it is not, is partially or is completely stabilized by yttrium oxide and/or calcium oxide and/or magnesium oxide may also be present on the MCrAlX. Columnar grains are produced in the thermal barrier coating by suitable coating processes, such as for example electron beam physical vapor deposition (EB-PVD).

The guide vane 130 has a guide vane root (not shown here) facing the inner housing 138 of the turbine 108 and a guide vane head on the opposite side from the guide vane root. The guide vane head faces the rotor 103 and is fixed to a securing ring 140 of the stator 143.

1.-25. (canceled)

26. A coating system, comprising:
a substrate;
a porous ceramic layer arranged on the substrate, wherein the porous ceramic layer has a porosity of ≧20 vol % and ≦30 vol %; and
an abradable ceramic layer arranged on the porous ceramic layer.

27. The coating system of claim 26, wherein the porous ceramic layer comprises ZrO2 which is stabilized by Yb2O3 and/or Y2O3.

28. The coating system of claim 27, wherein the ZrO2 of the porous ceramic layer is stabilized by 8 wt % Y2O3.

29. The coating system of claim 28, wherein the porous layer is 190 μm to 240 μm thick.

30. The coating system of claim 29, wherein the abradable ceramic layer has a porosity of ≧27 vol % and ≦35 vol %.

31. The coating system of claim 30, wherein the abradable ceramic layer comprises ZrO2 stabilized by Yb2O3 and/or Y2O3.

32. The coating system of claim 31, wherein the abradable ceramic layer comprises Yb2O3 between 30 wt % and 40 wt %.

33. The coating system of claim 32, wherein the abradable ceramic layer is 300 μm to 800 μm thick.

34. The coating system of claim 33, further comprising a bond coat arranged on the substrate and/or an oxide layer arranged on the bond coat.

35. The coating system of claim 34, further comprising a ceramic layer arranged below the porous ceramic layer.

36. The coating system of claim 35, wherein the ceramic layer has a smaller porosity than the porous ceramic layer and the ceramic layer has a porosity of 6 vol % to 17 vol %.

37. The coating system of claim 36, wherein the ceramic layer comprises ZrO2 stabilized by Yb2O3 and/or Y2O3.

38. The coating system of claim 37, wherein the ZrO2 of the ceramic layer is stabilized with 6 wt % to 10 wt % Y2O3.

39. The coating system of claim 38, wherein the ceramic layer is 20 μm to 200 μm thick.

40. The coating system of claim 39, wherein the ceramic layer, the porous ceramic layer and the abradable ceramic layer are together 650 μm to 950 μm thick.

41. The coating system of claim 40, further comprising a metallic bond coat arranged below the porous ceramic layer or the ceramic layer.

42. The coating system of claim 41, wherein the bond coat is 100 μm to 260 μm thick.

43. The coating system of claim 42, further comprising a bond coat arranged on the substrate and/or an oxide layer arranged on the bond coat.

44. The coating system of claim 26, wherein the substrate is a gas turbine component.

45. An assembly of gas turbine components, comprising:
a first gas turbine component, wherein the first component is movable about a rotational axis of the turbine;
a second gas turbine component arranged relative to the first gas turbine component such that a gap is provided between the components; and
a coating system arranged on either the first or second or both first and second gas turbine components wherein the coating system comprises:
a porous ceramic layer arranged on the substrate, wherein the porous ceramic layer comprises ZrO2 stabilized by Yb2O3 and/or Y2O3 and has a porosity between ≧20 vol % and ≦30 vol %, and
an abradable ceramic layer arranged on the porous ceramic layer.
